(19) United States
(12) Patent Application Publication
(10) Pub. No.: US 2007/0209287 A1
(43) Pub. Date: Sep. 13, 2007

(54) Composition and method to polish silicon nitride

(75) Inventors: Zhan Chen, Aurora, IL (US); Robert Vacassy, Aurora, IL (US); Phillip W. Carter, Naperville, IL (US); Jeffrey M. Dysard, St. Charles, IL (US)

Correspondence Address: STEVEN WESEMAN;ASSOCIATE GENERAL COUNSEL, I.P., CABOT MICROELECTRONICS CORPORATION, 870 NORTH COMMONS DRIVE, AURORA, IL, 60504, US

(73) Assignee: Cabot Microelectronics Corporation, Aurora, IL (US)

(21) Appl. No.: 11/374,238

(22) Filed: Mar. 13, 2006

(51) Int. Cl. B24D 3/02; B24B 7/30; B24B 29/00; C09K 3/14; B24B 1/00

(52) U.S. Cl. 51/307; 51/308; 451/41; 451/285

(57) ABSTRACT

The inventive chemical-mechanical polishing composition comprises an abrasive, a nitride accelerator, and water, and has a pH of about 1 to about 6. The inventive method of polishing a substrate involves the use of the aforesaid polishing composition and is particularly useful in polishing a substrate containing silicon nitride.

### FIELD OF THE INVENTION

The invention pertains to chemical-mechanical polishing compositions and methods.

### BACKGROUND OF THE INVENTION

Integrated circuits are made up of millions of active devices formed in or on a substrate, such as a silicon wafer. The active devices are chemically and physically connected into a substrate and are interconnected through the use of multilevel interconnects to form functional circuits. Typical multilevel interconnects comprise a first metal layer, an interlevel dielectric layer, and sometimes a second and subsequent metal layer(s). Interlevel dielectrics, such as doped and undoped silicon dioxide (SiO₂) and/or low-κ dielectrics, are used to electrically isolate the different metal layers. As each layer is formed, typically the layer is planarized to enable subsequent layers to be formed on top of the newly formed layer.

Tungsten is increasingly being used as a conductive material to form the interconnections in integrated circuit devices. One way to fabricate planar tungsten circuit traces on a silicon dioxide substrate is referred to as the damascene process. In accordance with this process, the silicon dioxide dielectric surface having a layer of silicon nitride deposited thereon is patterned by applying a photoresist, exposing the photoresist to irradiation through a pattern to define trenches and/or vias, and then using a conventional dry etch process to form holes and trenches for vertical and horizontal interconnects. The silicon nitride functions as a “hard mask” to protect the silicon dioxide surface that is not part of the trenches and/or vias from damage during etching. The patterned surface is coated with an adhesion-promoting layer such as titanium and/or a diffusion barrier layer such as titanium nitride. The adhesion-promoting layer and/or the diffusion barrier layer are then over-coated with a tungsten layer. Chemical-mechanical polishing is employed to reduce the thickness of the tungsten over-layer, as well as the thickness of any adhesion-promoting layer and/or diffusion barrier layer, until a planar surface that exposes elevated portions of the silicon nitride surface is obtained. The vias and trenches remain filled with electrically conductive tungsten forming the circuit interconnects.

Since polishing compositions and methods useful for the planarization or polishing of tungsten are typically not effective for planarization or polishing of silicon nitride, generally the silicon nitride layer is removed using a plasma dry etch or by use of a second polishing operation with a suitable polishing composition. Further, since polishing compositions suitable for polishing of tungsten and polishing compositions suitable for polishing of silicon nitride and silicon oxide are typically incompatible, the second polishing step is usually carried out using a different polishing apparatus, thereby adding to the complexity and cost of the overall operation. Further, polishing compositions currently used for polishing substrates comprising silicon nitride and silicon oxide typically exhibit faster removal rates for silicon oxide as compared with silicon nitride. Thus, as the silicon nitride is removed to expose underlying silicon oxide, the silicon oxide can be overpolished with resulting poor planarity of the substrate surface. Thus, a need remains in the art for polishing compositions and methods having improved selectivity for silicon nitride compared to silicon oxide and having compatibility with existing tungsten polishing compositions.

### BRIEF SUMMARY OF THE INVENTION

The invention provides a chemical-mechanical polishing composition comprising (a) an abrasive, (b) a component or components that accelerate the removal rate of silicon nitride relative to silicon oxide, and (c) water, wherein the polishing composition has a pH of about 1 to about 6.

A first embodiment of the inventive chemical-mechanical polishing composition comprises (a) an abrasive, (b) about 0.1 mM to about 10 mM malonic acid, (c) about 0.1 mM to about 100 mM of an aminocarboxylic acid, (d) about 0.1 mM to about 100 mM sulfate ion, and (e) water, wherein the polishing composition has a pH of about 1 to about 6.

A second embodiment of the inventive chemical-mechanical polishing composition comprises (a) an abrasive, (b) about 0.1 mM to about 25 mM of an organic acid selected from the group consisting of aryldicarboxylic acids, phenylacetic acids, and combinations thereof, and (c) water, wherein the polishing composition has a pH of about 1 to about 6.

A third embodiment of the inventive chemical-mechanical polishing composition comprises (a) an abrasive, (b) about 0.001 mM to about 100 mM of potassium stannate, and (c) water, wherein the polishing composition has a pH of about 1 to about 6.

A fourth embodiment of the inventive chemical-mechanical polishing composition comprises (a) an abrasive, (b) about 0.001 wt. % to about 1 wt. % uric acid, and (c) water, wherein the polishing composition has a pH of about 1 to about 6.

The invention also provides a method for chemically-mechanically polishing a substrate with the inventive chemical-mechanical polishing composition.

A first embodiment of the inventive method for chemically-mechanically polishing a substrate comprises (i) contacting a substrate comprising silicon nitride and silicon oxide with a polishing pad and a polishing composition comprising (a) an abrasive, (b) about 0.1 mM to about 10 mM malonic acid, (c) about 0.1 mM to about 100 mM of an aminocarboxylic acid, (d) about 0.1 mM to about 100 mM sulfate ion, and (e) water, (ii) moving the polishing pad relative to the substrate, and (iii) abrading at least a portion of the substrate to polish the substrate, wherein the polishing composition has a pH of about 1 to about 6.

A second embodiment of the inventive method for chemically-mechanically polishing a substrate comprises (i) contacting a substrate comprising silicon nitride and silicon oxide with a polishing pad and a polishing composition comprising (a) an abrasive, (b) about 0.1 mM to about 25 mM of an organic acid selected from the group consisting of aryldicarboxylic acids, phenylacetic acids, and combinations thereof, and (c) water, (ii) moving the polishing pad relative to the substrate, and (iii) abrading at least a portion of the substrate to polish the substrate, wherein the polishing composition has a pH of about 1 to about 6.

A third embodiment of the inventive method for chemically-mechanically polishing a substrate comprises (i) contacting a substrate comprising silicon nitride and silicon oxide with a polishing pad and a polishing composition comprising (a) an abrasive, (b) about 0.001 mM to about 100 mM of potassium stannate, and (c) water, (ii) moving the polishing pad relative to the substrate, and (iii) abrading at least a portion of the substrate to polish the substrate, wherein the polishing composition has a pH of about 1 to about 6.

A fourth embodiment of the inventive method for chemically-mechanically polishing a substrate comprises (i) contacting a substrate comprising silicon nitride and silicon oxide with a polishing pad and a polishing composition comprising (a) an abrasive, (b) about 0.001 wt. % to about 1 wt. % uric acid, and (c) water, (ii) moving the polishing pad relative to the substrate, and (iii) abrading at least a portion of the substrate to polish the substrate, wherein the polishing composition has a pH of about 1 to about 6.

### DETAILED DESCRIPTION OF THE INVENTION

The invention provides a chemical-mechanical polishing composition comprising (a) an abrasive, (b) a component or components that accelerate the removal rate of silicon nitride relative to silicon oxide, and (c) water, wherein the polishing composition has a pH of about 1 to about 6. The component(s) that accelerate the removal rate of silicon nitride relative to silicon oxide are referred to herein as “nitride accelerators.”

The polishing composition comprises an abrasive. The abrasive can be any suitable abrasive, many of which are well known in the art. The abrasive desirably comprises a metal oxide. Suitable metal oxides include metal oxides selected from the group consisting of alumina, ceria, silica, zirconia, and combinations thereof. Preferably, the metal oxide is silica. The silica can be any suitable form of silica. Useful forms of silica include but are not limited to fumed silica, precipitated silica, and condensation-polymerized silica. Most preferably, the silica is a condensation-polymerized silica. Condensation- polymerized silica particles typically are prepared by condensing Si(OH)₄ to form colloidal particles. The precursor Si(OH)₄ can be obtained, for example, by hydrolysis of high purity alkoxysilanes, or by acidification of aqueous silicate solutions. Such abrasive particles can be prepared in accordance with U.S. Pat. No. 5,230,833 or can be obtained as any of various commercially available products, such as the Fuso PL-1, PL-2, and PL-3 products, and the Nalco 1050, 2327, and 2329 products, as well as other similar products available from DuPont, Bayer, Applied Research, Nissan Chemical, and Clariant. As is well known in the art, abrasive particles comprise, at the lowest level of structure, primary particles. Primary particles are formed by covalent bonds between atoms comprising the particles and are stable to all but the harshest conditions. At the next level of structure, primary particles are associated into secondary particles, generally referred to as aggregates. Aggregate particles comprise primary particles and are bonded together by covalent bonds and electrostatic interactions, and typically are resistant to degradation by, e.g., mechanical energy inputs such as high-shear mixing. At the next level of structure, aggregates are more loosely associated into agglomerates. Typically, agglomerates can be disassociated into the constituent aggregates via mechanical energy inputs. Depending on the particular composition and method of preparation, primary particles and secondary particles (e.g., aggregates) can have shapes ranging from spherical to elliptical, and some aggregates can have extended, chain-like structures. For example, pyrogenic, or fumed, silica typically exists in the form of aggregates having a chain-like structure. Precipitated silicas, for example, silicas prepared by neutralization of sodium silicate, have an aggregate structure in which approximately spherical primary particles are associated into aggregates that resemble a “bunch of grapes.” Both primary abrasive particles and aggregated primary particles (e.g., secondary particles) can be characterized as having an average particle size. In this regard, particle size refers to the diameter of the smallest sphere that encloses the particle.

The abrasive typically has a primary particle size of about 5 nm or more (e.g., about 10 nm or more, or about 15 nm or more, or about 20 nm or more). Preferably, the abrasive has a primary particle size of about 150 nm or less (e.g., about 100 nm or less, or about 75 nm or less, or about 50 nm or less, or even about 30 nm or less). More preferably, the abrasive has a primary particle size of about 5 nm to about 50 nm, or about 10 nm to about 40 nm, or about 15 nm to about 35 nm, or about 20 nm to about 30 nm.

When the abrasive comprises aggregates of primary particles, the abrasive typically has an aggregate particle size of about 20 nm or more (e.g., about 30 nm or more, or about 40 nm or more, or about 50 nm or more). Preferably, the abrasive has an aggregate particle size of about 250 nm or less (e.g., about 200 nm or less, or about 150 nm or less, or about 100 nm or less, or even about 75 nm or less). More preferably, the abrasive has an aggregate particle size of about 20 nm to about 125 nm, or about 30 nm to about 100 nm, or about 40 nm to about 90 nm, or about 50 nm to about 80 nm.

The abrasive desirably is suspended in the polishing composition, more specifically in the water of the polishing composition. When the abrasive is suspended in the polishing composition, the abrasive preferably is colloidally stable. The term colloid refers to the suspension of abrasive particles in the water. Colloidal stability refers to the maintenance of that suspension over time. In the context of this invention, an abrasive is considered colloidally stable if, when the abrasive is placed into a 100 ml graduated cylinder and allowed to stand unagitated for a time of 2 hours, the difference between the concentration of particles in the bottom 50 ml of the graduated cylinder ([B] in terms of g/ml) and the concentration of particles in the top 50 ml of the graduated cylinder ([T] in terms of g/ml) divided by the initial concentration of particles in the abrasive composition ([C] in terms of g/ml) is less than or equal to 0.5 (i.e., {[B]-[T]}/[C]≦0.5). The value of [B]-[T]/[C] desirably is less than or equal to 0.3, and preferably is less than or equal to 0.1.

Any suitable amount of abrasive can be present in the polishing composition. Typically, about 0.01 wt. % or more abrasive can be present in the polishing composition (e.g., about 0.05 wt. % or more, or about 0.1 wt. % or more, or about 1 wt. % or more). The amount of abrasive in the polishing composition preferably will not exceed about 10 wt. %, and more preferably will not exceed about 8 wt. % (e.g., will not exceed about 6 wt. %). Even more preferably the abrasive will comprise about 0.5 wt. % to about 10 wt. % (e.g., about 1 wt. % to about 6 wt. %) of the polishing composition.

The polishing composition comprises water. The water is used to facilitate the application of the abrasive particles, nitride accelerator, and any other additives to the surface of a suitable substrate to be polished or planarized. Preferably, the water is deionized water.

The polishing composition has a pH of about 6 or less (e.g., about 5 or less, or about 4 or less). Preferably, the polishing composition has a pH of about 1 or more (e.g., about 2 or more). Even more preferably, the polishing composition has a pH of about 1 to about 5 (e.g., about 2 to about 4). The polishing composition optionally comprises pH adjusting agents, for example, potassium hydroxide, ammonium hydroxide, alkylammonium hydroxides, and/or nitric acid. The polishing composition optionally comprises pH buffering systems. Many such pH buffering systems are well known in the art. The pH buffering agent can be any suitable buffering agent, for example, phosphates, sulfates, acetates, borates, ammonium salts, and the like. The polishing composition can comprise any suitable amount of a pH adjustor and/or a pH buffering agent, provided that a suitable amount is used to achieve and/or maintain the pH of the polishing composition within a suitable range.

In a first embodiment, the invention provides a chemical-mechanical polishing composition comprising (a) an abrasive, (b) about 0.1 mM to about 10 mM malonic acid, (c) about 0.1 mM to about 100 mM of an aminocarboxylic acid, (d) about 0.1 mM to about 100 mM sulfate ion, and (e) water, wherein the polishing composition has a pH of about 1 to about 6.

The polishing composition of the first embodiment comprises malonic acid. Malonic acid includes the free acid as well as the mono- and di-salts thereof. When salts of malonic acid are used in the polishing composition, the salts can comprise any cation, or mixtures of cations. Examples of suitable cations include potassium, ammonium, tetraalkylammonium, and the like.

The polishing composition can comprise any suitable concentration of malonic acid. Typically, the concentration of malonic acid in the polishing composition is about 0.1 mM or more (e.g., about 0.5 mM or more). The concentration of malonic acid in the polishing composition is preferably about 10 mM or less (e.g., about 7.5 mM or less, or about 5 mM or less). More preferably, the concentration of malonic acid in the polishing composition is about 0.5 mM to about 5 mM. The desired concentration of malonic acid can be achieved by any suitable means, such as by using about 0.001 wt. % to about 0.1 wt. % of malonic acid based on the weight of the water and any components dissolved or suspended therein in the preparation of the polishing composition.

The polishing composition of the first embodiment comprises an aminocarboxylic acid. The aminocarboxylic acid can be any suitable aminocarboxylic acid, provided that the aminocarboxylic acid has a water solubility such that the aminocarboxylic acid is substantially dissolved in the water of the polishing composition at the concentration employed. Preferably, the aminocarboxylic acid is selected from the group consisting of glycine, α-alanine, β-alanine, serine, histidine, derivatives thereof, and salts thereof. More preferably, the aminocarboxylic acid is glycine. It will be appreciated that the aforementioned aminocarboxylic acids can exist in the form of a salt of the carboxylic acid group (e.g., a metal salt, an ammonium salt, or the like), as well as in the acid form, in which the aminocarboxylic acid is a zwitterion. Furthermore, aminocarboxylic acids include basic amine functional groups which can exist in the form of an acid salt of the amine group (e.g., a hydrochloride salt or a sulfate salt).

The polishing composition can comprise any suitable concentration of aminocarboxylic acid. Typically, the concentration of aminocarboxylic acid in the polishing composition is about 0.1 mM or more (e.g., about 0.5 mM or more). The concentration of aminocarboxylic acid in the polishing composition is preferably about 100 mM or less (e.g., about 75 mM or less, or about 50 mM or less). More preferably, the concentration of aminocarboxylic acid in the polishing composition is about 0.5 mM to about 50 mM (e.g., about 1 mM to about 40 mM, or about 10 mM to about 30 mM). The desired concentration of aminocarboxylic acid can be achieved by any suitable means, such as by using about 0.001 wt. % to about 1 wt. % of aminocarboxylic acid based on the weight of the water and any components dissolved or suspended therein in the preparation of the polishing composition.

The polishing composition of the first embodiment comprises sulfate ion. It will be appreciated that, depending on the pH of the polishing composition, the sulfate ion also can exist in a monoprotonated form (i.e., hydrogen sulfate) as well as in its diprotonated form (i.e., sulfuric acid). Thus, in the context of the invention, the term sulfate refers to the species SO₄²⁻ as well as its mono- and di-protonated acid forms.

The sulfate ion can be provided by use of any suitable sulfate-containing compound. For example, an appropriate amount of sulfuric acid can be added to the polishing composition, followed by in situ adjustment of the pH of the polishing composition. Alternatively, the polishing composition can comprise a suitable amount of a basic compound so that, upon addition of an appropriate amount of sulfuric acid, the pH of the polishing composition will be as recited herein. The sulfate ion can be provided in the form of a salt of a monovalent cation having the formula: M₂SO₄ wherein M can be any suitable monovalent cation, for example, a monovalent metal ion (e.g., Na, K, Li), an ammonium cation, a tetraalkylammonium cation, or an acid addition salt of the aminocarboxylic acid of the polishing composition. The sulfate ion can be provided in the form of a mono-salt of a monovalent cation having the formula: MHSO₄ wherein M can be as recited herein. The sulfate ion can be provided in the form of a salt of a divalent cation having the formula: MSO₄ wherein M can be any suitable divalent cation, provided that the salt has a water solubility so as to be substantially dissolved in the polishing composition. The sulfate ion can be provided in part or completely as a sulfate salt or a hydrogensulfate salt of the aminocarboxylic acid. The sulfate ion also can be provided in the form of a sulfate salt of a cationic polymer. Non-limiting examples of cationic polymers include amine-containing polymers and copolymers, many of which are well known in the art.

The polishing composition can comprise any suitable concentration of sulfate ion. Typically, the concentration of sulfate ion in the polishing composition is about 0.1 mM or more (e.g., about 0.5 mM or more, or about 1 mM or more). Preferably, the concentration of sulfate ion in the polishing composition is about 100 mM or less (e.g., about 75 mM or less, or about 50 mM or less). More preferably, the concentration of sulfate ion in the polishing composition is about 1 mM to about 50 mM (e.g., about 2.5 mM to about 25 mM).

In a second embodiment, the invention provides a chemical-mechanical polishing composition comprising (a) an abrasive, (b) about 0.1 mM to about 25 mM of an organic acid selected from the group consisting of aryldicarboxylic acids, phenylacetic acids, and combinations thereof, and (c) water, wherein the polishing composition has a pH of about 1 to about 6.

The polishing composition of the second embodiment comprises an organic acid selected from the group consisting of aryldicarboxylic acids, phenylacetic acids, and combinations thereof. Preferred examples of aryldicarboxylic acids include phthalic acid, isophthalic acid, terephthalic acid, and 2,3-naphthalenedicarboxylic acid. More preferably, the aryldicarboxylic acid is phthalic acid. Preferred examples of phenylacetic acids include phenylacetic acid, 2-hydroxyphenylacetic acid, 3-hydroxyphenylacetic acid, 4-hydroxyphenylacetic acid, and mandelic acid. More preferably, the phenylacetic acid is mandelic acid. In a preferred embodiment, the polishing composition comprises a mixture of phthalic acid and mandelic acid. Without wishing to be bound by any particular theory, it is believed that aryldicarboxylic acids and phenylacetic acids interact with silicon nitride surfaces so as to inhibit or disrupt formation of an electrical double layer thereon.

The polishing composition of the second embodiment can comprise any suitable concentration of an aryldicarboxylic acid and/or a phenylacetic acid. Typically, the polishing composition comprises about 0.1 mM or more (e.g., about 0.5 mM or more, or about 1 mM or more, or about 2 mM or more, or about 5 mM or more) of an aryldicarboxylic acid and/or a phenylacetic acid. Preferably, the polishing composition comprises about 25 mM or less (e.g., about 20 mM or less, or about 15 mM or less) of an aryldicarboxylic acid and/or a phenylacetic acid. More preferably, the polishing composition comprises about 1 mM to about 25 mM (e.g., about 2 mM to about 20 mM, or about 5 mM to about 15 mM) of an aryldicarboxylic acid and/or a phenylacetic acid.

In a third embodiment, the invention provides a chemical-mechanical polishing composition comprising (a) an abrasive, (b) about 0.001 mM to about 100 mM of potassium stannate, and (c) water, wherein the polishing composition has a pH of about 1 to about 6.

The polishing composition of the third embodiment comprises potassium stannate. Potassium stannate has the formula K₂SnO₃ and is commercially available as the trihydrate.

The polishing composition of the third embodiment can comprise any suitable concentration of potassium stannate. Typically, the polishing composition comprises about 0.001 mM or more (e.g., about 0.01 mM or more, or about 0.1 mM or more) of potassium stannate. Preferably, the polishing composition comprises about 100 mM or less (e.g., about 50 mM or less, or about 25 mM or less, or about 10 mM or less) of potassium stannate. More preferably, the polishing composition comprises about 0.01 mM to about 50 mM of potassium stannate (e.g., about 0.1 mM to about 10 mM).

In a fourth embodiment, the invention provides a chemical-mechanical polishing composition comprising (a) an abrasive, (b) about 0.001 wt. % to about 1 wt. % uric acid, and (c) water, wherein the polishing composition has a pH of about 1 to about 6.

The polishing composition of the fourth embodiment can comprise any suitable amount of uric acid. Typically, the polishing composition comprises about 0.001 wt. % or more (e.g., about 0.05 wt. % or more) of uric acid. Preferably, the polishing composition comprises about 1 wt. % or less (e.g., about 0.5 wt. % or less) of uric acid. More preferably, the polishing composition comprises about 0.01 wt. % to about 0.5 wt. % of uric acid.

The polishing composition of the invention can be prepared by any suitable technique, many of which are known to those skilled in the art. The polishing composition can be prepared in a batch or continuous process. Generally, the polishing composition can be prepared by combining the components thereof in any order. The term “component” as used herein includes individual ingredients (e.g., abrasive, nitride accelerators, etc.) as well as any combination of ingredients (e.g., abrasive, nitride accelerators, buffers, etc.).

For example, in one embodiment, the abrasive can be dispersed in water. The aminocarboxylic acid and malonic acid can then be added, and mixed by any method that is capable of incorporating the components into the polishing composition. Sulfate ion can be added at any point in the process. The sulfate ion can be added in the form of sulfuric acid or an aqueous solution thereof to a mixture of the abrasive, malonic acid, and aminocarboxylic acid. Alternatively, the sulfate ion can be provided in the form of a sulfate salt or hydrogen sulfate salt of the aminocarboxylic acid. Other nitride accelerators similarly can be utilized in the preparation of the polishing composition. The polishing composition can be prepared prior to use, with one or more components, such as a pH adjusting component, added to the polishing composition just before use (e.g., within about 7 days before use, or within about 1 hour before use, or within about 1 minute before use). The polishing composition also can be prepared by mixing the components at the surface of the substrate during the polishing operation.

The polishing composition also can be provided as a concentrate which is intended to be diluted with an appropriate amount of water prior to use. In such an embodiment, the polishing composition concentrate can comprise, for example, an abrasive, malonic acid, an aminocarboxylic acid, sulfate ion, and water in amounts such that, upon dilution of the concentrate with an appropriate amount of water, each component of the polishing composition will be present in the polishing composition in an amount within the appropriate range recited above for each component. For example, the abrasive, malonic acid, an aminocarboxylic acid, and sulfate ion can each be present in the concentrate in an amount that is about 2 times (e.g., about 3 times, about 4 times, or about 5 times) greater than the concentration recited above for each component so that, when the concentrate is diluted with an equal volume of water (e.g., 2 equal volumes water, 3 equal volumes of water, or 4 equal volumes of water, respectively), each component will be present in the polishing composition in an amount within the ranges set forth above for each component. Furthermore, as will be understood by those of ordinary skill in the art, the concentrate can contain an appropriate fraction of the water present in the final polishing composition in order to ensure that the malonic acid, aminocarboxylic acid, sulfate ion, and other suitable additives are at least partially or fully dissolved in the concentrate. Other nitride accelerators similarly can be utilized in a concentrate.

The invention further provides a method of chemically-mechanically polishing a substrate comprising (i) contacting a substrate with a polishing pad and the polishing composition described herein, (ii) moving the polishing pad relative to the substrate with the polishing composition therebetween, and (iii) abrading at least a portion of the substrate to polish the substrate.

The method of the invention can be used to polish any suitable substrate, and is especially useful for polishing substrates comprising silicon nitride and silicon dioxide. Suitable substrates include wafers used in the semiconductor industry. The polishing composition is particularly well-suited for planarizing or polishing a substrate comprising tungsten, silicon nitride, and silicon oxide that has undergone so-called damascene processing. Damascene processing typically involves providing a silicon substrate upon which is deposited a layer of silicon oxide and then a layer of silicon nitride. A pattern of trenches and/or vias is defined on the top layer of the substrate by photolithography, and then the patterned regions are etched to provide trenches and/or vias in the substrate surface. The substrate is overcoated with tungsten to fill the trenches and/or vias, and the excess tungsten is removed by chemical-mechanical planarization using a polishing composition suitable for polishing tungsten so that the tungsten in the trenches and/or vias is substantially level with the silicon nitride resident on the substrate surface. Desirably, the planarization or polishing of the silicon nitride to remove the silicon nitride and expose the silicon oxide is carried out with the polishing composition of the invention, preferably such that the silicon nitride is substantially removed and the silicon dioxide is adequately planarized without excessive erosion of silicon dioxide on the substrate surface. Advantageously, the polishing composition of the invention is compatible with polishing compositions suitable for the polishing or planarization of tungsten, such that the polishing of silicon nitride with the inventive polishing composition can be carried out after the polishing or planarization of tungsten, on the same polishing apparatus and using the same polishing pad.

The polishing method of the invention is particularly suited for use in conjunction with a chemical-mechanical polishing (CMP) apparatus. Typically, the apparatus comprises a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing pad and the polishing composition of the invention and then the polishing pad moving relative to the substrate, so as to abrade at least a portion of the substrate to polish the substrate.

A substrate can be planarized or polished with the chemical-mechanical polishing composition with any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof.

Desirably, the CMP apparatus further comprises an in situ polishing endpoint detection system, many of which are known in the art. Techniques for inspecting and monitoring the polishing process by analyzing light or other radiation reflected from a surface of the substrate are known in the art. Desirably, the inspection or monitoring of the progress of the polishing process with respect to a substrate being polished enables the determination of the polishing end-point, i.e., the determination of when to terminate the polishing process with respect to a particular substrate. Such methods are described, for example, in U.S. Pat. Nos. 5,196,353, 5,433,651, 5,609,511, 5,643,046, 5,658,183, 5,730,642, 5,838,447, 5,872,633, 5,893,796, 5,949,927, 5,964,643.

The following examples further illustrate the invention but, of course, should not be construed as in any way limiting its scope.

In the examples below, the polishing experiments generally involved use of a 50.8 cm (20 inch) diameter polishing tool with 22.5 kPa (3.3 psi) downforce pressure of the substrate against the polishing pad, 22.5 kPa (3.3 psi) subcarrier pressure, 22.5 kPa (3.3 psi) back side pressure, 20 kPa (2.9 psi) ring pressure, 100 rpm platen speed, 55 rpm carrier speed, 150 mL/min polishing composition flow rate, and use of ex-situ conditioning of a concentric grooved CMP pad.

### EXAMPLE 1

This example demonstrates the effect of sulfate ions on removal rates for silicon nitride and silicon dioxide layers observed with the polishing composition of the invention.

Eight different polishing compositions were used to separately chemically-mechanically polish similar silicon nitride and silicon dioxide layers (Compositions 1A-1H). Each of the polishing compositions comprised 5 wt. % condensation-polymerized silica (the PL-2 product of Fuso Chemical Company, having a primary particle size of about 25 nm), 2.5 mM malonic acid, and 20 mM glycine, at a pH of 3.3 in water. Composition 1A (control) contained no further ingredients. Composition 1B (comparative) further contained 10 mM potassium nitrate. Composition 1C (comparative) further contained 10 mM ammonium nitrate. Composition 1D (comparative) further contained 10 mM calcium nitrate. Composition 1E (comparative) further contained 10 mM potassium bromide. Composition 1F (comparative) further contained 10 mM potassium dihydrogen phosphate. Composition 1G (invention) further contained 10 mM potassium sulfate. Composition 1H (invention) further contained 10 mM ammonium sulfate. Following use of the polishing compositions, the silicon nitride removal rate (“Nitride RR”) and silicon dioxide removal rate (“Oxide RR”) were determined, and the selectivities, defined by the equation Selectivity=Nitride RR/Oxide RR, were calculated. The results are set forth in Table 1.

TABLE 1
Effect of different salts on silicon nitride and silicon dioxide removal rates

| Polishing | | | |
|---|---|---|---|
| Composition | Nitride RR (Å/min) | Oxide RR (Å/min) | Selectivity |
| 1A (control) | 403 | 1434 | 0.281 |
| 1B (comparative) | 322 | 990 | 0.325 |
| 1C (comparative) | 338 | 1019 | 0.332 |
| 1D (comparative) | 352 | 946 | 0.372 |
| 1E (comparative) | 314 | 1086 | 0.289 |
| 1F (comparative) | 545 | 1141 | 0.478 |
| 1G (invention) | 677 | 1176 | 0.576 |
| 1H (invention) | 742 | 1108 | 0.670 |

As is apparent from the results set forth in Table 1, the presence of 10 mM potassium sulfate (Composition 1G) or 10 mM ammonium sulfate (Composition 1H) to a polishing composition comprising condensation-polymerized silica, malonic acid, and glycine, at a pH of 3.3, in water resulted in silicon nitride removal rates approximately 1.68 and 1.84 times that observed with the control polishing composition, and silicon oxide removal rates approximately 0.82 and 0.77 times that observed with the control polishing composition, respectively. With the exception of Composition 1F, all other additives resulted in a reduced silicon nitride removal rate as observed with the control polishing composition. In addition, inventive Compositions 1G and 1H exhibited an approximately 24% and 36% greater silicon nitride removal rate and an approximately 21% and 40% increase in silicon nitride/silicon oxide selectivity, respectively, as compared with Composition 1F, which contained 10 mM potassium hydrogen phosphate. These results demonstrate the improved silicon nitride removal rate and improved selectivity of silicon nitride to silicon oxide exhibited by the inventive polishing composition.

### EXAMPLE 2

This example illustrates the effect of the presence of the inventive nitride accelerators in a polishing composition comprising condensation-polymerized silica on the polishing of substrates comprising silicon nitride and silicon oxide.

Six different polishing compositions were used to separately chemically-mechanically polish similar silicon nitride and silicon dioxide layers (Compositions 2A-2F). Each of the polishing compositions comprised 5 wt. % of condensation-polymerized silica (the PL-2 product of Fuso Chemical Company, having a primary particle size of about 25 nm) at a pH of 3-4 in water. Composition 2A (control) contained no further ingredients. Composition 2B (invention) further contained 10 mM mandelic acid. Composition 2C (invention) further contained 10 mM phthalic acid. Composition 2D (invention) further contained 5 mM mandelic acid and 5 mM phthalic acid. Composition 2E (invention) further contained 10 mM uric acid. Composition 2F (invention) further contained 0.33 mM potassium stannate. Following use of the polishing compositions, the silicon nitride removal rate (“Nitride RR”) and silicon dioxide removal rate (“Oxide RR”) were determined, and the selectivities, defined by the equation Selectivity=Nitride RR/Oxide RR, were calculated. The results are set forth in Table 2.

TABLE 2
Effects of nitride accelerators on silicon nitride
and silicon dioxide removal rates

| Polishing | | | |
|---|---|---|---|
| Composition | Nitride RR (Å/min) | Oxide RR (Å/min) | Selectivity |
| 2A (control) | 403 | 1434 | 0.281 |
| 2B (invention) | 616 | 945 | 0.652 |
| 2C (invention) | 923 | 1069 | 0.864 |
| 2D (invention) | 994 | 733 | 1.36 |
| 2E (invention) | 663 | 187 | 3.55 |
| 2F (invention) | 888 | 568 | 1.56 |

As is apparent from the results set forth in Table 2, each of the inventive polishing compositions exhibited a silicon nitride removal rate of approximately 1.5 to 2.5 times greater than the silicon nitride removal rate exhibited by the control polishing composition. Each of the inventive polishing compositions further exhibited a silica oxide removal rate of approximately 0.13 to 0.75 of the silicon oxide removal rate exhibited by the control polishing composition. In addition, each of the inventive polishing compositions exhibited silicon nitride/silicon oxide selectivity approximately 2.3 to 12.6 times the silicon nitride/silicon oxide selectivity exhibited by the control polishing composition. These results demonstrate the improved silicon nitride removal rate and improved selectivity of silicon nitride to silicon oxide exhibited by the inventive polishing composition.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical-mechanical polishing composition comprising:
(a) an abrasive,
(b) about 0.1 mM to about 10 mM malonic acid,
(c) about 0.1 mM to about 100 mM of an aminocarboxylic acid,
(d) about 0.1 mM to about 100 mM sulfate ion, and
(e) water,
wherein the polishing composition has a pH of about 1 to about 6.

2. The polishing composition of claim 1, wherein the abrasive is condensation-polymerized silica.

3. The polishing composition of claim 2, wherein the condensation-polymerized silica is present in the amount of about 0.5 wt. % to about 10 wt. %.

4. The polishing composition of claim 1, wherein the aminocarboxylic acid is glycine.

5. The polishing composition of claim 4, wherein the glycine is present at a concentration of about 10 mM to about 30 mM.

6. The polishing composition of claim 1, wherein the sulfate ion is present at a concentration of about 2.5 mM to about 25 mM.

7. The polishing composition of claim 1, wherein the polishing composition has a pH of about 2 to about 4.

8. A chemical-mechanical polishing system comprising a polishing pad and the polishing composition of claim 1.

9. A chemical-mechanical polishing composition comprising:
(a) an abrasive,
(b) about 0.1 mM to about 25 mM of an organic acid selected from the group consisting of aryldicarboxylic acids, phenylacetic acids, and combinations thereof, and
(c) water,
wherein the polishing composition has a pH of about 1 to about 6.

10. The polishing composition of claim 9, wherein the abrasive is condensation-polymerized silica.

11. The polishing composition of claim 9, wherein the aryldicarboxylic acid is phthalic acid.

12. The polishing composition of claim 9, wherein the phenylacetic acid is mandelic acid.

13. The polishing composition of claim 9, wherein the organic acid is a combination of phthalic acid and mandelic acid.

14. The polishing composition of claim 9, wherein the polishing composition has a pH of about 2 to about 4.

15. A chemical-mechanical polishing system comprising a polishing pad and the polishing composition of claim 9.

16. A chemical-mechanical polishing composition comprising:
(a) an abrasive,
(b) about 0.001 mM to about 100 mM of potassium stannate, and
(c) water,
wherein the polishing composition has a pH of about 1 to about 6.

17. The polishing composition of claim 16, wherein the abrasive is condensation-polymerized silica.

18. The polishing composition of claim 16, wherein the potassium stannate is present at a concentration of about 0.1 mM to about 10 mM.

19. The polishing composition of claim 16, wherein the polishing composition has a pH of about 2 to about 4.

20. A chemical-mechanical polishing system comprising a polishing pad and the polishing composition of claim 16.

21. A chemical-mechanical polishing composition comprising:
(a) an abrasive,
(b) about 0.001 wt. % to about 1 wt. % uric acid, and
(c) water,
wherein the polishing composition has a pH of about 1 to about 6.

22. The polishing composition of claim 21, wherein the abrasive is condensation-polymerized silica.

23. The polishing composition of claim 21, wherein the uric acid is present in an amount of about 0.01 wt. % to about 0.5 wt. %.

24. The polishing composition of claim 21, wherein the polishing composition has a pH of about 2 to about 4.

25. A chemical-mechanical polishing system comprising a polishing pad and the polishing composition of claim 21.

26. A method for chemically-mechanically polishing a substrate, which method comprises:
(i) contacting a substrate comprising silicon nitride and silicon oxide with a polishing pad and the polishing composition of claim 1,
(ii) moving the polishing pad relative to the substrate, and
(iii) abrading at least a portion of the substrate to polish the substrate.

27. The method of claim 26, wherein the abrasive is condensation-polymerized silica.

28. The method of claim 27, wherein the condensation-polymerized silica is present in the amount of about 0.5 wt. % to about 10 wt. %.

29. The method of claim 26, wherein the aminocarboxylic acid is glycine

30. The method of claim 29, wherein the glycine is present at a concentration of about 10 mM to about 30 mM.

31. The method of claim 26, wherein the sulfate ion is present at a concentration of about 2.5 mM to about 25 mM.

32. The method of claim 26, wherein the polishing composition has a pH of about 2 to about 4.

33. A method for chemically-mechanically polishing a substrate, which method comprises:
(i) contacting a substrate comprising silicon nitride and silicon oxide with a polishing pad and the polishing composition of claim 9,
(ii) moving the polishing pad relative to the substrate, and
(iii) abrading at least a portion of the substrate to polish the substrate.

34. The method of claim 33, wherein the abrasive is condensation-polymerized silica.

35. The method of claim 33, wherein the aryldicarboxylic acid is phthalic acid.

36. The method of claim 33, wherein the phenylacetic acid is mandelic acid.

37. The method of claim 33, wherein the organic acid is a combination of phthalic acid and mandelic acid.

38. The method of claim 33, wherein the polishing composition has a pH of about 2 to about 4.

39. A method for chemically-mechanically polishing a substrate, which method comprises:
(i) contacting a substrate comprising silicon nitride and silicon oxide with a polishing pad and the polishing composition of claim 16,
(ii) moving the polishing pad relative to the substrate, and
(iii) abrading at least a portion of the substrate to polish the substrate.

40. The method of claim 39, wherein the abrasive is condensation-polymerized silica.

41. The method of claim 39, wherein the potassium stannate is present at a concentration of about 0.1 mM to about 10 mM.

42. The method of claim 39, wherein the polishing composition has a pH of about 2 to about 4.

43. A method for chemically-mechanically polishing a substrate, which method comprises:
(i) contacting a substrate comprising silicon nitride and silicon oxide with a polishing pad and the polishing composition of claim 21,
(ii) moving the polishing pad relative to the substrate, and
(iii) abrading at least a portion of the substrate to polish the substrate.

44. The method of claim 43, wherein the abrasive is condensation-polymerized silica.

45. The method of claim 43, wherein the uric acid is present in an amount of about 0.01 wt. % to about 0.5 wt. %.

46. The method of claim 43, wherein the polishing composition has a pH of about 2 to about 4.
